(19) United States
(12) Patent Application Publication
(10) Pub. No.: US 2004/0014865 A1
(43) Pub. Date: Jan. 22, 2004

(54) Composition for producing surfaces which are difficult to wet

(76) Inventors: Harald Keller, Ludwigshafen (DE); Ekkehard Jahns, Weinheim (DE); Christian Lach, Bad Durkheim (DE); Stephen Huffer, Ludwigshafen (DE); Thilo Krebs, Mannheim (DE); Yi Thomann, Umkirch (DE); Thomas Frechen, Heidelberg (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/399,139

(22) PCT Filed: Oct. 12, 2001
(86) PCT No.: PCT/EP01/11847

(30) Foreign Application Priority Data
Oct. 13, 2000 (DE) 100507883

(51) Int. Cl. B05D 1/12; C08K 3/34; C08K 11/00

(52) U.S. Cl. 524/442; 427/180; 524/492

(57) ABSTRACT

The invention relates to a composition comprising at least one hydrophylic, inorganic powder (P) having an average particle size of between 15 and 500 μm, and at least one hydrophobic, thermoplastic substance (T) which is characterised by a surface tension of between 20 and 50 mN/m. The weight ratio of the hydrophylic, inorganic powder to the hydrophobic, thermoplastic substance P:T is between 50:1 and 1:2.

The present invention relates to compositions which encompass at least one hydrophilic, inorganic powder P with a particle size in the range from 15 to 500 μm, and encompass at least one hydrophobic, thermoplastic substance T, and to the use of these compositions for producing low-wettability surfaces.

Conventional surfaces are generally wetted by liquids. The degree of wetting depends on interaction between the cohesive forces within the liquid and the adhesive forces between liquid and surface.

In many instances, wetting of a surface by a liquid is undesirable. For example, the wetting of surfaces with water causes water droplets to remain on the surface and evaporate, whereupon the solids suspended or dissolved in water remain in the form of unsightly residues on the surface. This problem arises in particular on surfaces exposed to rainwater.

The wetting of a surface with water also frequently causes its corrosion or infestation with microorganisms, or else the growth of algae, lichens, mosses, bivalves, etc.

In the case of packaging and storage containers for liquid contents, low wettability of the internal surfaces is desirable so that only small amounts of liquid remain in the packaging or in the storage container when it is emptied.

Low wettability of plant components which are in contact with liquids is also desirable in chemical engineering and terotechnology. Specifically, if components of the plant have high wettability there is a risk that formation of deposits and encrustation will increase. In addition, increased wettability generally results in increased flow resistance to liquids in pipelines.

It is known that the wettability of a surface for hydrophilic liquids can be reduced by giving the surface a hydrophobic coating. The coating materials used here are polysiloxanes, (per)fluorinated polymers, in particular polytetrafluoroethylene (Teflon), which is extremely hydrophobic, and fluorinated organic waxes. Fluorinated or perfluorinated polymers and fluorinated organic waxes generally have surface tension<20 mN/m. Coating reduces the adhesive forces between liquid and wetted surface.

It has also proven advantageous to structure hydrophobic surfaces. These surface structures generally have regular or irregular elevations or depressions in the range from 0.1 to 1 000 μm. The structuring further reduces the adhesion of the surface with respect to polar liquids, such as water, and also leads to reduced adhesion of solid deposits, such as dirt particles, to the surface. It has also been found that the dirt particles are washed off the surface by moving water if suitable structuring is present. This effect is also termed self-cleaning effect or lotus effect (see Barthlott et al., Biologie in unserer Zeit, 28, No. 5, 314-322).

By way of example, WO 96/04123 describes self-cleaning surfaces of articles which have an artificial surface structure with elevations and depressions, a particular characteristic of the structure being the distance between the elevations and the height of the elevations. An example of a method for producing the surfaces is application of Teflon powder to an adhesive-treated surface, or the application of a structure by embossing a hydrophobic material capable of thermoplastic deformation.

U.S. Pat. No. 3,354,022 discloses similar surfaces. Here again, the surface is produced either by applying a structure by embossing or by applying hydrophobic particles, such as wax particles, to a hydrophobic surface. Another surface described is composed of wax-coated glass powder having a particle size of from 3 to 12 μm.

EP 933 388 discloses a process for producing structured surfaces with hydrophobic properties by first producing a negative mold via photolithography, and using this to emboss a polymer film, and then hydrophobicizing the polymer film with fluoroalkylsilanes.

EP-A 909 747 describes a process for rendering ceramics, such as roof tiles, self-cleaning by applying a dispersion of clay particles in an organic silicone resin solution to the ceramic and curing the coating.

JP 7328532-A discloses a coating process in which fine particles having a hydrophobic surface are applied to a lacquer which is not fully dried, which is then cured. The result here is water-repellent surfaces.

The methods described in the prior art for producing low-wettability surfaces are either very complicated or do not lead to satisfactory results. The production of a structured surface by embossing methods is complicated and is only cost-effective when used on flat surfaces. Surfaces which have a structuring achieved by subsequent application of hydrophobic particles often have poor reproducibility or only low mechanical stability. This process is moreover also very complicated. In addition, fluorinated organic compounds or fluorinated polymers are often needed, and are not only very expensive but also pose environmental problems.

It is an object of the present invention, therefore, to provide compositions which are suitable for producing surfaces with low wettability, and which overcome the disadvantages of the prior art.

This object is achieved by way of a composition encompassing at least one hydrophobic thermoplastic substance T which is characterized by a surface tension in the range from 20 to 50 mN/m and encompassing at least one hydrophilic finely divided powder P having a particle size in the range from 15 to 500 μm, and where the ratio by weight of hydrophilic, inorganic powder to hydrophobic thermoplastic substance P:T is in the range from 1:2 to 50:1.

The invention therefore provides these compositions, and their use for producing low-wettability surfaces.

To produce low-wettability surfaces, the coating compositions can be applied simply as coatings to surfaces. They reduce the wettability of the surface to almost zero and create a self-cleaning effect on these surfaces. The present invention therefore also provides a process for producing low-wettability surfaces by applying a coating composition of the invention to a surface to be coated, and also provides the use of the coating compositions for producing surfaces with self-cleaning effects. The compositions of the invention may also be used for reducing the flow resistance in pipes, by coating the inner walls of the pipes with the compositions of the invention.

To characterize the wettability of surfaces, the static contact angle of a liquid droplet on a surface may be utilized. The static contact angle is defined as the angle included by said surface and a tangent to the surface of the liquid droplet in the region of the point of contact of the liquid droplet with the surface, the contact angle being measured through the liquid droplet. A contact angle of 0° therefore means complete wettability and no droplet formation, whereas a contact angle of 180° means complete non-wettability. The contact angle may be determined by known methods, for example with the aid of a microscope equipped with a goniometer (see also C. D. Bain et al., Angew. Chem. 101 (1989) 522-528, and A. Born et al., Farbe & Lack 105 (1999) pp. 96-104).

The surfaces treated with the coating compositions of the invention generally have static contact angles (determined at room temperature)≧120°, and in particular≧140°, and particularly≧160°, for a very wide variety of liquids, in particular for water. Indeed, contact angles>160° are often achieved, in particular for water. Contact angles above 160° cannot generally be determined with adequate precision. However, a contact angle above 160° generally means complete non-wettability of the surface.

Another measure of the wettability of a surface is “Repellent Power” F_{R}, defined as the reciprocal of the gravitational force F_{H} required to cause a liquid droplet to run off an inclined surface. This “Repellent Power” is calculated from the following formula:

$${F}_{R} = \frac{1}{{F}_{H}} = \frac{1}{sin α \cdot m \cdot g}$$

m here is the weight of the liquid droplet, g is the acceleration due to gravity, and α is the minimum possible inclination of the test surface from the horizontal sufficient to cause the liquid droplet to run off this surface.

The hydrophobic thermoplastic substances T present in the compositions of the invention interact with the hydrophilic powder and thus lead to surfaces substantially composed of this composition and having low wettability and a self-cleaning effect. They also act as binders and thus serve to fix the powder particles on the surface.

The hydrophobic properties of the thermoplastic substance T are characterized by way of its surface tension, which can be determined, by way of example, by measuring the static contact angle of water on a smooth surface coated with the substance T. The substances T present in the compositions of the invention have static contact angles of at least 90° for water. Another method of determining hydrophobic properties is the “pendant drop” method (see S. Wu, “Polymer Interface and Adhesion”, Marcel Decker Inc., New York 1982, pp. 266-268). The values given for the surface tension of the binders here and below are based on the values determined by the “pendant drop method”. For the purposes of the invention, hydrophobic binders have surface tension in the range from 20 to 50 mN/m. The surface tension of commercially available hydrophobic substances T is in some cases given in the literature; see, for example, Wu et al. loc. cit. pp. 88 et seq., and S. Ellefson et al. J. Am. Ceram. Soc. 21, 193, (1938); S. Wu, J. Colloid Interface Sci. 31, 153, (1969), J. Phys. Chem. 74, 632 (1970), J. Polym. Sci, C34, 19, (1971); R. J. Roe et al., J. Phys. Chem. 72, 2013 (1968), J. Phys. Chem. 71, 4190 (1967), J. Colloid Interface Sci. 31, 228, (1969); J. F. Padday in “Surface and Colloid Science (ed. E. Matijevic), Wiley, New York 1969, pp. 101-149.

According to the invention, preference is given to those binders whose surface energy is <42 mN/m, and in particular <37 mN/m.

The substances T are generally thermoplastic or film-forming polymers soluble in organic solvents. Other substances T which may be used are organic prepolymers which are crosslinked by a thermal, oxidative or photochemical curing process and thus form a solid coating with the powder.

The nature of the substance T often depends on the desired application, and is of fairly minor importance for the success of the invention, as long as the level of its hydrophobic properties is within the range of the invention. These substances generally have a plurality of hydrocarbon radicals having at least four carbon atoms, e.g. linear or branched alkyl or alkenyl or cycloalkyl having at least 4, preferably from 5 to 30, and in particular from 8 to 24, carbon atoms, and/or have relatively long hydrocarbon segments generally having at least 4, preferably at least 6, saturated carbon atoms bonded to one another. Examples of these hydrocarbon segments are linear or branched C₄-Cₙ-alkylene groups, preferably C₆-Cₙ-alkylene groups, and C₅-C₁₀-cycloalkylene groups, n being an integer>4 and, respectively, >6. The proportion of hydrocarbon chains or hydrocarbon segments is generally at least 50% by weight, and in particular at least 60% by weight, of the substance T.

Examples of substances T are fatty acids having more than 8 carbon atoms, in particular ethylenically unsaturated fatty acids, and esters of these with polyhydric alcohols, such as glycerol, ethylene glycol, propanediol, sorbitol, glucose, sucrose, or trimethylolpropane. These fatty acids and their esters undergo oxidative hardening and are therefore classified as prepolymers. Other substances T are naturally occurring waxes, such as beeswax, carnauba wax, lanolin, candelilla wax, and also synthetic waxes, such as montanic acid waxes, montanic ester waxes, amide waxes, e.g. distearoylethylenediamine, Fischer-Tropsch waxes, and waxy polymers of ethylene and of propylene (polyethylene wax, polypropylene wax).

The substances T are preferably oligomers or polymers having a number-average molecular weight above 1 000 dalton, in particular above 1 500 dalton, and in particular above 2 000 dalton, and the upper molar mass limit here can be 10 million g/mol. The molar mass is preferably in the range from 2 500 to 5 million g/mol (determined by viscometry).

Examples of these substances T are homo- or copolymers of ethylenically unsaturated monomers M whose structure is composed of at least 50% by weight of ethylenically unsaturated monomers A having C₅-C₃₀-alkyl groups or C₅-C₁₀-cycloalkyl groups, and also, where appropriate, of suitable comonomers B.

Examples of these monomers A are:

monothylenically unsaturated ethers and esters of C₅-C₃₀ alkanols or of C₅-C₁₀ cycloalkanols, e.g. their vinyl, allyl and methallyl ethers, e.g. vinyl hexyl ether, vinyl n-octyl ether, vinyl lauryl ether, vinyl stearyl ether (vinyl octadecyl ether), vinyl cyclopentyl ether, and vinyl cyclohexyl ether;

esters and half-esters of ethylenically unsaturated C₃-C₈ mono- or dicarboxylic acids with C₅-C₃₀ alkanols or with C₅-C₁₀ cycloalkanols, e.g. the esters and half-esters of acrylic acid, of methacrylic acid, of maleic acid, or of fumaric acid, e.g. n-hexyl(meth)acrylate, cyclohexyl (meth)acrylate, 2-ethylhexyl (meth)acrylate, 2-propylheptyl (meth)acrylate, n-decyl (meth)acrylate, lauryl (meth)acrylate, and stearyl (meth)acrylate, bis(n-hexyl) maleate, bis(n-hexyl) fumarate, bis(2-ethylhexyl) maleate, bis(2-ethylhexyl) fumarate, bis(2-propylheptyl) maleate, bis(2-propylheptyl) fumarate, bis(n-decyl) maleate, bis(n-decyl) fumarate, dilauryl maleate, dilauryl fumarate, distearyl maleate, or distearyl fumarate;

amides of ethylenically unsaturated monocarboxylic acids with C₅-C₃₀ alkylamines or with C₅-C₁₀ cycloalkylamines, N-(n-hexyl)acrylamide and -methacrylamide, N-(n-octyl)acrylamide and -methacrylamide, N-(n-dodecyl)acrylamide and -methacrylamide, and also N-(stearyl)acrylamide and -methacrylamide;

vinyl, allyl, and methallyl esters of aliphatic carboxylic acids having from 6 to 30 carbon atoms, such as vinyl hexanoate, vinyl octanoate, vinyl laurate, vinyl stearate, vinyl cyclohexanoate; and also

C₇-C₃₂ olefins, such as n-heptene, n-octene, isooctene, n-decene, dodecene, isotridecene, and also oligoolefin mixtures with terminal double bond and from 10 to 32 carbon atoms, and the like.

The nature of the comonomers B is relatively unimportant. In principle, use may be made of any of the ethylenically unsaturated monomers which are copolymerizable with the monomers A. These include monoethylenically unsaturated mono- and dicarboxylic acids, such as acrylic acid, methacrylic acid, maleic acid, fumaric acid, crotonic acid, itaconic acid, amides of these, such as acrylamide, methacrylamide, maleimide, their esters with C₁-C₅ alkanols, e.g. methyl acrylate, methyl methacrylate, ethyl acrylate, ethyl methacrylate, n-butyl acrylate, isobutyl acrylate, tert-butyl acrylate, n-butyl methacrylate, isobutyl methacrylate, tert-butyl methacrylate, conjugated diolefins, such as butadiene and isoprene, vinyl and allyl esters of aliphatic carboxylic acids having from 2 to 5 carbon atoms, e.g. vinyl acetate, vinyl propionate, vinyl butyrate, and vinyl pivalate, vinylaromatic monomers, such as styrene, tert-butylstyrene, and vinyltoluene, ethylenically unsaturated nitriles, such as acrylonitrile and methacrylonitrile, and also halogenated olefins, such as vinyl chloride, vinylidene chloride, chlorodifluoroethene, vinylidene fluoride, and tetrafluoroethane.

Specific examples of homo- and copolymers of the monomers A are the poly-C₅-C₃₀-alkyl vinyl ethers, e.g. polyoctadecyl vinyl ether, which preferably have a molecular weight in the range from 2 000 to 20 000, in particular in the range from 2 500 to 10 000 dalton (determined by viscometry), copolymers of the abovementioned ethylenically unsaturated mono- and dicarboxylic acids with C₇-C₃₂ olefins, e.g. the copolymers of maleic acid with C₇-C₃₂ olefins, and also reaction products of these copolymers with fatty alcohols of chain length C₈-C₃₂, or with fatty amines of chain length C₈-C₃₂, the homo- and copolymers of esters of acrylic acid and/or of methacrylic acid with, where appropriate, C₅-C₃₀ alkanols with Cₗ-C₄-alkyl (meth)acrylates, with vinylaromatics, and/or with vinyl C₂-C₅-alkanoates, and, where appropriate, with other comonomers B.

Other preferred substances T are oligo- and poly-C₂-C₇-olefins, such as polyethylene, polypropylene, polyisobutene, e.g. with molecular weights in the range from 10 000 to 10 000 000 (determined by viscometry).

Other suitable substances T are polymers whose structure is composed almost exclusively of, i.e. at least 99% by weight of, C₃-C₁₂-alkyl esters of acrylic acid and/or of methacrylic acid, and also copolymers in which up to 50% of these monomers have been replaced by monomers A other than these or by monomers B with water solubility<10 g/l. Particular examples of these polymers are poly-n-butyl acrylate and methacrylate, and also poly-tert-butyl acrylate and methacrylate.

Other suitable substances T are poly-C₁-C₄-alkylene oxides, such as polyoxymethylene, polypropylene oxide, and polybutylene oxide, polytetrahydrofuran, and polycaprolactone, polycarbonates, polyvinylbutyral, polyvinylformal, and also linear or branched polydialkylsiloxanes, such as polydimethylsiloxane (silicones).

Other suitable materials are polymers having siloxane side chains of the formula I

—X[(CH₂)ₐO_{b}—(Si(CH₃)₂O)_{c}R]ₙ (I)

where X is oxygen if n=1 or is nitrogen if n=2, a is an integer from 1 to 2 000, and R is hydrogen, trimethylsilyl, or C₁-C₈-alkyl.

These polymers are obtainable by homo- or copolymerization of ethylenically unsaturated monomers B of the formula II, where appropriate together with the abovementioned monomers A and/or C

CH₂═C(R′)-Y-X[(CH₂)ₐO_{b}—(Si(CH₃)₂O)_{c}R]ₙ (II)

where R′ is hydrogen or methyl and Y is C(O), CH₂ or a chemical bond, and X, a, b, c, R, and n are as defined above.

Other suitable substances T are aliphatic or partly aromatic polyesters made from aliphatic or aromatic dicarboxylic acids and from aliphatic and/or aromatic diols, e.g.:

aliphatic polyesters derived from aliphatic dialcohols having from 2 to 18 carbon atoms, e.g. propanediol, butanediol, hexanediol, and from aliphatic dicarboxylic acids having from 3 to 18 carbon atoms, such as adipic acid and decanedicarboxylic acid;

partly aromatic polyesters derived from bisphenol A and from the abovementioned dicarboxylic acids having from 3 to 18 carbon atoms; and also

partly aromatic polyesters derived from terephthalic acid and from aliphatic dialcohols having from 2 to 18 carbon atoms and dicarboxylic acids having from 3 to 18 carbon atoms.

The polyesters may optionally have been terminated with long-chain monoalcohols having from 4 to 24 carbon atoms, e.g. 2-ethylhexanol or octadecanol. The polyesters may moreover have been terminated with long-chain monocarboxylic acids having from 4 to 24 carbon atoms, e.g. stearic acid.

Typical photochemically and/or thermally crosslinkable binders are the polymers or, respectively, oligomers which have ethylenically unsaturated double bonds and are used in preparing radiation-curable lacquers and which, based on their total weight, have at least 50% by weight of C₅-C₃₀-alkyl groups, C₅-C₁₀-cycloalkyl groups, or hydrocarbon segments having at least 4, preferably at least 6, aliphatic carbon atoms. Examples of these include flowable preparations of polyether acrylates, of polyester acrylates, of polyurethane acrylates, or of polyesters incorporating condensed maleic anhydride units, and also include epoxy resins, e.g. aromatic epoxy resins, the oligomers or polymers here having been dissolved, where appropriate, in organic solvents and/or reactive diluents to improve their flowability. Reactive diluents are low-molecular-weight, ethylenically unsaturated liquids which form the coating with the ethylenically unsaturated polymers on crosslinking. The skilled worker is well aware of radiation-curable binders and preparations comprising these binders, e.g. from P. K. T. Oldring (ed.) “Chemistry and Technology of UV & EB Formulation for Coatings, Inks & Paints”, Vol. 2, 1991, Sita Technology London, and are commercially available, e.g. with the trademarks Laromer®P084F, Laromer®LR8819, Laromer®PE55F, Laromer®LR8861, BASF Aktiengesellschaft, Ludwigshafen.

The powders present in the compositions of the invention are hydrophilic, i.e. are wetted by water. They are generally oxidic materials, preferably silicates or silica or quartz, aluminosilicates, clay minerals, aluminum oxides, titanium dioxide, or inorganic carbonates, e.g. alkaline earth metal carbonates, such as magnesium carbonate, calcium carbonate (chalk) or dolomite, or alkaline earth metal sulfates, such as calcium sulfate or barium sulfate, e.g. the former in the form of gypsum.

Preference is given to powders P with average particle sizes (weight-average particle diameters) in the range from 20 to 300 μm, in particular with average particle sizes in the range from 20 to 200 μm, particularly preferably in the range from 20 to 150 μm, and very particularly preferably in the range from 20 to 100 μm. The proportion by weight of the particles with sizes above 500 μm is preferably less than 10%, in particular less than 5%. The proportion by weight of particles with sizes below 15 μm is likewise generally less than 10%, in particular less than 5%. Particular preference is given to powders where 90% by weight of the powder particles have sizes in the range from 20 to 200 μm, particularly preferably in the range from 20 to 150 μm and very particularly preferably in the range from 20 to 100 μm.

Preferred powders P have a structure substantially composed of silicates or of SiO₂. Examples of these are sand, e.g. with particle sizes in the range from 20 to 200 μm, in particular from 30 to 100 μm, powdered glass or powdered quartz, in each case preferably with particle sizes below 250 μm, in particular below 200 μm, particularly preferably below 150 μm, and with particular preference below 100 μm. Another suitable hydrophilic powder is fumed silica, for example that obtainable commercially with the trademark AEROSIL®, e.g. AEROSIL®380 (Degussa-Hüls AG).

To achieve the low-wettability effect desired according to the invention, it has proven advantageous for the ratio by weight of powder P to substance T in the compositions of the invention to be at least 1.1:1, in particular at least 1.5:1, particularly preferably at least 2:1, and very particularly preferably at least 3:1. The ratio by weight is preferably not more than 20:1, in particular not more than 15:1, and particularly preferably not more than 10:1.

The compositions of the invention are suitable either as coating compositions, i.e. for the coating of conventional surfaces, or else as molding compositions for producing moldings. Due to the use of thermoplastic binders, the compositions of the invention are thermoplastically processable by the methods customarily used for that purpose.

Coatings are produced by applying the compositions of the invention to the conventional surface to be coated, in a known manner. Moldings are produced from the compositions of the invention by using the compositions of the invention as starting material for known shaping processes, in particular using thermoplastic processes, for example pressure-molding, e.g. hot pressure-molding, hot rolling, injection molding, or extrusion of the compositions of the invention above the melting point or sintering temperature of the thermoplastic substance T. The starting materials for processing to give moldings may be either solvent-containing compositions or else solid compositions, e.g. compositions in powder form or in pellet form.

Depending on the application, the compositions of the invention may be formulated dry, i.e. as a powder preparation which encompasses the fine-particle powder P together with the hydrophobic substance T.

In another preferred embodiment, however, the compositions of the invention are formulated to be flowable at the temperature of processing. The compositions of the invention may, of course, be processed either at room temperature or else at temperatures below or above room temperature, e.g. at temperatures in the range from 0 to 300° C., preferably from 0 to 250° C., in particular from 10 to 200° C., depending on the nature of the composition.

Where appropriate, a flowable form of the compositions of the invention generally comprises, besides the powder P and the hydrophobic substance T, an organic diluent or organic solvent, preference being given to those solvents which dissolve or swell the substances T. This improves the coating.

Suitable solvents are volatile organic solvents which evaporate, where appropriate through heating, after use of the composition of the invention, e.g. after application of a composition formulated as a coating composition, thus allowing a uniform film of the substance T to form. Examples of suitable solvents are ketones, such as acetone, ethyl methyl ketone, volatile esters of acetic acid, e.g. ethyl acetate, n-butyl acetate, cyclic ethers, such as tetrahydrofuran, and also aliphatic or aromatic hydrocarbons, such as terpentine oil, petroleum, petroleum spirit, toluene, and xylene. Preferred organic solvents are the abovementioned aliphatic or aromatic hydrocarbons.

In the liquid formulations, the solids content (total amount of powder P and substance T, based on the total weight of the formulation) is in the range from 0.5 to 90% by weight. In conventional paints, the solids content is often in the range from 20 to 90% by weight. In sprayable lacquers, it may also be lower, e.g. in the range from 0.5 to 20% by weight.

The compositions of the invention may also be formulated as aerosols. They then comprise, besides the powder P and the substance T, at least one propellant, and also, where appropriate, one of the solvents mentioned in the context of the liquid formulations. Examples of propellants are the substances customarily used for this purpose, such as propane, butane, dimethyl ether, CO₂, N₂O, and mixtures of these. The solids content of sprays is generally in the ranges customary for this purpose, for example in the range from 0.1 to 10% by weight, and the solids here may also encompass solid additives, besides the components P and T. The remaining content of the coating compositions formulated as aerosols is made up by propellant gases and, where appropriate, solvents.

In principle, any conventional surface may be coated using the compositions of the invention. Examples of conventional surfaces are the surfaces of wood, metal, e.g. steel or stainless steel, glass, or plastic. The coating compositions of the invention may, of course, also be used to coat rough or porous surfaces, such as concrete, plaster, paper, or fabric, e.g. textiles for clothing, umbrellas, tenting, awnings, or for comparable applications, or indeed leather or even hair.

The composition is applied to the surface to be coated (hereinafter also termed substrate) by one of the application methods customary in coating technology, depending on the form of the composition, hereinafter termed coating composition, and the nature of the substrate. In the case of solvent-containing, flowable coating compositions, application is generally by brushing, doctoring, spraying, e.g. by means of an airbrush, dipping, or rolling, and then drying of the coating, whereupon the solvent evaporates.

If the substance T used comprises a prepolymer crosslinkable thermally, oxidatively, or photochemically, the coating compositions are then often flowable even without adding solvents and may be applied by the abovementioned process, where appropriate after dilution with a reactive diluent. The actual coating is then formed by thermal, oxidative, or photochemical curing (crosslinking) of the prepolymers.

In the case of pulverulent coating compositions, the powder coating methods customary in powder coating technology are used.

In these methods, the desired amount of the pulverulent coating composition is applied to the substrate to be coated, and then heated, whereupon the thermoplastic polymer binder melts and forms a polymeric film which fixes the powder particles of the invention on the surface.

To achieve the desired effect, the preferred amount of the coating composition to apply to the surface to be coated is at least 0.01 g/m², in particular at least 0.1 g/m², and specifically at least 0.5 g/m², but preferably not more than 1 000 g/m², based on the solid constituents in the coating composition. Solid constituents here are substantially components i) and ii). The corresponding residual weight of the coating per unit of surface area, after evaporation of volatile constituents, is then at least 0.01 g/m², in particular at least 0.1 g/m², and specifically at least 0.5 g/m². The amounts of the coatings applied to the surface to be coated are often up to 300 g/m² (based on solid constituents), but larger amounts of coating composition are applied in other types of use, for example in the case of coatings taking the form of facade paints, renders, or jointing materials, or in the coating of concrete roof tiles, of other roof tiles, of ornamental concrete, of washed concrete, of masonry, or of concrete-containing composite materials.

It has also proven advantageous to roughen the surfaces provided with the binders of the invention, e.g. by grinding, for example by treatment with a fine-grain, 80-400-grain abrasive, or by sandblasting, shotblasting, or brushing. This further improves the water-repellency of the surface of the invention.

The substrates coated with the coating compositions of the invention have very low adhesion to liquids and solids. Liquids, in particular hydrophilic liquids, such as water, aqueous solutions, dispersions, and suspensions, and polar organic liquids, in particular those which are water-soluble, e.g. C₁-C₄ alkanols, glycols, glycerol, and mixtures of these, and also melts of polar organic compounds, e.g. of carbohydrates and of comparable compounds, run off these coatings leaving no residue.

In addition, the surfaces coated with the coating compositions of the invention exhibit a self-cleaning effect. Solids, in particular particulate solids, can be removed from the surface by washing with liquids, such as water, with no cleaning agents. Surprisingly, the particulate solids can also be removed very easily by compressed air.

The moldings of the invention likewise have these properties. Surprisingly, the moldings do not moreover lose these properties when their surface is damaged, for example by scratches, notches, cracks, or similar damage due to mechanical action. These types of damage can also be repaired, e.g. through removal by grinding, without loss of the properties.

In addition, when liquids, in particular water and aqueous solutions, flow through pipes, capillaries, or nozzles coated with the coatings of the invention they experience less flow resistance.

The properties of the coating compositions of the invention give them a wide variety of uses.

Materials susceptible to corrosion, for example concrete, reinforced concrete, wood, or metal, can be given effective protection from corrosion through coating with the coating compositions of the invention.

The coating compositions of the invention are moreover suitable for the surface-finishing of paper, paperboard, or polymer films.

The coating compositions of the invention can be used to treat electrical devices exposed to weathering and subject to soiling under the conditions of weathering, e.g. high-voltage lines, voltage converters, insulators, parabolic antennas, etc., which suffer loss of performance when soiled or wet. The result is less soiling and no loss of performance.

The coating compositions of the invention are moreover suitable for preventing the soiling in particular of surfaces exposed to weathering, e.g. of roofs, facades, windows, garden furniture, balcony furniture, motor vehicles, traffic signs, advertising panels, solar installations, etc. The coating compositions of the invention may also be used in the sanitary sector, e.g. as a coating for fittings, wetrooms, bathtubs, swimming pools, wall tiles, floor tiles, etc. The use of the coating compositions here not only prevents the deposition of contaminants from the water, but also prevents infestation by, and growth of, undesired organisms, such as microorganisms, algae, lichens, and mosses.

The coating compositions of the invention may moreover also be used for the coating of system components which come into contact with liquids. Particular mention may be made here of pipes, boilers, tanks, reactors, heat exchangers, evaporators, condensers, pumps, nozzles, atomizers, spray dryers, crystallizers, fill systems, etc. When these system components are provided with the coating compositions of the invention, the deposition of solid constituents or decomposition products from the liquids is inhibited. The result is a reduction in the formation of encrustation, deposits, blockages, and soiling on the surfaces of the system components which come into contact with the liquids. In addition, the coatings reduce the flow resistance experienced by liquids in the system components, e.g. in pipes. They thus reduce the energy costs required for the transport, in particular of high-viscosity liquids, through the system components.

Icing, a frequently observed phenomenon, can be reduced when the cooling surfaces of cooling equipment are provided with the coating compositions of the invention. The use of the coating compositions of the invention for the coating of ships' hulls reduces the frictional resistance due to the water, thus reducing fuel consumption. In the case of aircraft, the risk of icing can be reduced by coating the external surfaces with the coating compositions of the invention.

Packaging intended for liquid products and provided with the coating compositions of the invention can be emptied leaving almost no residue, and thus permits better utilization of the contents and makes recycling of the packaging materials easier, since they have no contamination by residues of the contents.

Storage containers whose inner surfaces have been provided with the coating compositions of the invention are easier to empty and, due to the self-cleaning effect, can easily be cleaned by washing with water, without using surfactants.

Fabrics, in particular textiles, provided with the coating compositions of the invention have high impermeability to water and low water absorption, and are dirt-repellent. Treatment with the compositions of the invention makes the fabric highly water-repellent. Dirt particles can easily be washed off using water, without any significant water absorption. The coating compositions of the invention are therefore suitable for providing water-repellency and dirt-repellency to fabric, for example fabric which can be used for producing clothing, tenting, awnings, tarpaulins, umbrellas, or for lining spaces, e.g. motor vehicle interiors, or for upholstering seating, e.g. in the automotive sector.

Leather which has been treated with the coating compositions of the invention is suitable for the production of leather clothing and shoes with water-repellent and dirt-repellent properties.

In the cosmetics sector, the coating compositions of the invention may be used as a hair-treatment composition, e.g. in the form of hair sprays, as long as the binders which they comprise are substances T compatible with cosmetics, e.g. the polymers customarily used in cosmetics.

As mentioned above, the compositions of the invention may also be used as molding compositions to produce moldings. The present invention therefore also provides moldings encompassing at least one hydrophilic, inorganic powder P having a particle size in the range from 15 to 500 μm and at least one hydrophobic, thermoplastic substance T which is characterized by a surface tension in the range from 20 to 50 mN/m, where the ratio by weight of hydrophilic, inorganic powder to hydrophobic thermoplastic substance P:T is in the range from 1:2 to 50:1.

The advantageous properties of the moldings of the invention are comparable with those of articles which have a coating of the invention, i.e. their surface has extremely low wettability, in particular for the abovementioned hydrophilic liquids. Their surfaces have a self-cleaning effect. Moldings of the invention also have lower flow resistance than moldings manufactured from conventional materials. These properties are not lost even when the surface is damaged, e.g. by scratching. Surprisingly, the advantageous properties of the moldings can be still further improved by treatment with fine-grain abrasives.

The examples given here are intended to illustrate the invention but not to limit the same.

I. Analysis

I.1 General Specification for Determining Repellent Power

The coated article to be tested is mounted on a test table, the inclination of which can be adjusted from 1 to 90°. A cannula is then used to drop liquid droplets onto the specimen, the distance of the cannula from the specimen surface being 10 mm. The droplets have defined weight, determined by prior weighing. The minimum angle of inclination at which the droplets still just run off is determined by reducing the angle of inclination a stepwise.

The minimum angle of inclination α, the droplet weight m, and the acceleration due to gravity g are used to calculate the repellent power F_{R} from the abovementioned formula. Repellent power is stated in (millinewton)⁻¹ and is a quantitative measure of the ability of a surface to permit liquid droplets to run off leaving no residue.

I.2 Determination of Contact Angle:

Contact angle was determined using G1 equipment from Krüss GmbH. For this, a stainless steel cannula with internal diameter 0.5 mm was used to apply a droplet of distilled water to the surface to be tested. A goniometer was then used for optical determination of the contact angle between water droplet and surface. In the case of highly hydrophobic surfaces, such as those provided by the present invention, the water droplet practically ceases to adhere to the surface. On discharge from the stainless steel cannula, the water droplet then adheres to the cannula until its weight causes it to fall away. Precise determination of the contact angle becomes impossible for surfaces of this type, but it can be estimated at >160°.

II Production Examples:

### EXAMPLE 1

Coating Composition B1

1.5 g of polyoctadecyl vinyl ether with a molar mass of about 3 000 g/mol (determined by viscometry) were dissolved in 6 g of petroleum spirit (boiling range from 60 to 140° C.). 28.5 g of powdered quartz with a particle size below 250 μm (Mikrosil SP3 from Westdeutsche Quarzwerke GmbH) were added to this solution, and the entire material was mixed on rollers.

### EXAMPLE 2

Coating Composition B2

3 g of polyoctadecyl vinyl ether with a molar mass of about 3 000 g/mol (determined by viscometry) were dissolved in 6 g of petroleum spirit (boiling range from 60 to 140° C). 27 g of powdered quartz with a particle size below 250 μm (Mikrosil SP3 from Westdeutsche Quarzwerke GmbH) were added to this solution, and the entire material was mixed on rollers.

### EXAMPLE 3

Coating Composition B3

1.5 g of polyoctadecyl vinyl ether with a molar mass of about 3 000 g/mol (determined by viscometry) were dissolved in 8 g of petroleum spirit (boiling range from 60 to 140° C.). 28.5 g of powdered quartz with a particle size below 100 μm (Mikrosil SP10 from Westdeutsche Quarzwerke GmbH) were added to this solution, and the entire material was mixed on rollers.

### EXAMPLE 4

Coating Composition B4

3 g of polyoctadecyl vinyl ether with a molar mass of about 3 000 g/mol (determined by viscometry) were dissolved in 6 g of petroleum spirit (boiling range from 60 to 140° C.). 27 g of powdered quartz with a particle size below 100 μm (Mikrosil SP10 from Westdeutsche Quarzwerke GmbH) were added to this solution, and the entire material was mixed on rollers.

### EXAMPLE 5

Coating Composition B5

1.5 g of polyoctadecyl vinyl ether with a molar mass of about 3 000 g/mol (determined by viscometry) were dissolved in 7 g of petroleum spirit (boiling range from 60 to 140° C.). 28.5 g of powdered quartz with a particle size below 48 μm (Mikrosil LM300 from Westdeutsche Quarzwerke GmbH) were added to this solution, and the entire material was mixed on rollers.

### EXAMPLE 6

Coating Composition B6

3 g of polyoctadecyl vinyl ether with a molar mass of about 3 000 g/mol (determined by viscometry) were dissolved in 6 g of petroleum spirit (boiling range from 60 to 140° C.). 27 g of powdered quartz with a particle size below 48 μm (Mikrosil LM300 from Westdeutsche Quarzwerke GmbH) were added to this solution, and the entire material was mixed on rollers.

The polyoctadecyl vinyl ether used in the examples has surface tension of 27.7 mN/m, determined on a melt by the pendant drop method.

### EXAMPLE 7

Coating Composition B7

40 g of fumed silica (Aerosil® 380 from Degussa-Hüls AG) with a BET surface area of 380 m²/g (determined to DIN 66131) were suspended in 1 000 g of petroleum spirit (boiling range from 60 to 80° C.). To this mixture were added 60.8 g of a copolymer made from maleic acid and from a 1-olefin mixture (chain length C₂₀-C₂₄) in a molar ratio of 1:1 (number-average molar mass about 4 000 g/mol), and the mixture was stirred at 60° C. until the polymer had dissolved. The solvent was then removed in vacuo, and the residue was dried at 50° C. in a vacuum drying cabinet. The residue was then ground in a flying-blade mill to give a powder. 2 g of the powder were dispersed in 98 g of petroleum spirit (boiling range from 60 to 140° C.).

### EXAMPLE 8

Coating Composition B8

150 g of the hydrophobic polymer A described below, screen fraction 0-36 μm and 350 g of powdered quartz (Mikrosil LM 300 from Euroquarz with particle size distribution of 6-32 μm) were placed in a glass flask. The powder mixture was homogenized by rolling on laboratory rollers for some hours.

Preparation of Hydrophobic Polymer A in Powder Form

360.8 g of copolymer whose structure is composed of maleic anhydride and 1-olefin (mixture of C₂₀₋₂₄ chain lengths) in a molar ratio of 1:1 and 480 g of 1-octadecanol were placed in a sealed tubular apparatus. The mixture was stirred for 7 h at 140° C., with continuous nitrogen flushing. Cooling gave 832.3 g of colorless polymer with melting point 58° C. For subsequent use, the product was ground in an IKA A10 analytical mill, and the ground product was separated via a set of screens on a Fritsch Analysette vibratory screen machine. The 0-36 μm screen fractions were used.

### EXAMPLE 9

Molding composition F1

55 g of beach sand (36-63 μm screen fraction) were added at 70° C. to 45 g of polyoctadecyl vinyl ether with molar mass about 3 000 g/mol (determined by viscometry), and the mixture was homogenized by agitation.

### EXAMPLE 10

Molding Composition F2

120 g of beach sand (36-63 μm screen fraction) were added at 70° C. to 30 g of polyoctadecyl vinyl ether with molar mass about 3 000 g/mol (determined by viscometry), and the mixture was homogenized by adding 10 g of petroleum spirit (boiling range from 60 to 80° C.), with agitation.

### EXAMPLE 11

Molding Composition F3

32 g of gypsum plaster (gypsum plaster from Rigips GmbH) were added at 70° C. to 8 g of polyoctadecyl vinyl ether with molar mass about 3 000 g/mol (determined by viscometry), and the mixture was homogenized by adding 7 g of petroleum spirit (boiling range from 60 to 80° C.), with agitation.

### EXAMPLE 12

Molding Composition F4

45 g of gypsum plaster (gypsum plaster from Rigips GmbH) were added at 70° C. to 5 g of polyoctadecyl vinyl ether with molar mass about 3 000 g/mol (determined by viscometry), and the mixture was homogenized by adding 16 g of petroleum spirit (boiling range from 60 to 80° C.), with agitation.

### EXAMPLE 13

Molding Composition F5

Molding composition F2 was cast at 70° C. onto an aluminum foil. After cooling, the solid was ground in a flying-blade mill to give a powder.

### EXAMPLE 14

Molding Composition F6

30 g of polymer from example A were homogenized for some hours on laboratory rollers with 70 g of powdered quartz (Mikrosil LM 300 from Euroquarz with 6-32 μm grain size distribution), and then cast in aluminum. The mixture was heated to 70° C. for 3 h. Cooling gave sheets of thickness 5 mm.

III Applications:

III-1 Coatings

Coating composition B1 to B6 was applied to steel sheets (Bonder 26 S 60 OC from Chemmetall), using a box doctor system with a doctor gap of 400μ, and was dried at room temperature. Coating composition B8 was applied similarly, but with the difference that the steel sheet was preheated to 100° C. prior to the application process. After the application process and drying, the coatings were lightly abraded with abrasive paper (320 grain), and the abraded dust was removed by washing with water.

Coating composition B7 was sprayed uniformly onto a wooden board, using an airbrush (HY-MAX HP-101), and dried at room temperature.

The surfaces coated with coating compositions B1 to B7 are extremely hydrophobic. When water drops onto the material, the droplets run off the surface without wetting it. The static contact angle with respect to water was more than 160° in all cases.

The repellent power of the surfaces coated with coating compositions B1 to B7 is given in table 1. It was determined using droplets of deionized water. The droplet weight here was 4.3 mg.

TABLE 1

| | |
|---|---|
| Specimen | Repellent power |
| B1 | 60 mN⁻¹ |
| B2 | 91 mN⁻¹ |
| B3 | 80 mN⁻¹ |
| B4 | 296 mN⁻¹ |
| B5 | 104 mN⁻¹ |
| B6 | 169 mN⁻¹ |
| B7 | 100 mN⁻¹ |

Wettability Test:

The steel sheets coated with coating compositions B1 to B6 were placed on a test table arrangement for determination of repellent power. Using an angle of inclination of 10°, a defined amount of each of the following aqueous liquids was applied in succession in droplet form:

water (30 mg),

coffee (30 mg),

honey (59 mg),

aqueous hydrochloric acid (32% strength by weight, 41 mg),

aqueous sodium hydroxide solution (5% strength by weight, 45 mg),

30% strength by weight solution of polyacrylic acid in water (47 mg),

30% strength by weight solution of a copolymer of vinylpyrrolidone and vinylimidazole in water (35 mg).

Using an angle of inclination of 10° from the horizontal, all of the droplets ran off the coated steel sheets leaving no residue.

In a comparative experiment, the abovementioned liquids were applied to untreated steel sheets. The angle of inclination of the specimen was likewise 10° from the horizontal. In all cases, wetting of the surface occurred. All of the liquids except water left residues on the steel sheets.

Dirt Removal Test:

The steel sheets coated with B1 to B6 were soiled with carbon black powder (Printex® V, BASF Drucksysteme GmbH). Water was then dropped onto the coating. The result was complete removal of the carbon black powder by the water droplets as they ran off, thus regenerating the original surface. No use of cleaning agents was required.

In a comparative experiment, an untreated steel sheet was soiled with carbon black powder (Printex® V, BASF Drucksysteme GmbH). Water was then dropped onto the sheets. The result was only partial removal of the carbon black powder by the water droplets as they ran off, and specks of carbon black therefore remained on the steel sheet.

Coating of Steel Sheet with Coating Composition B8

The powder mixture B8 described was sprayed onto Bonder 26S 60 OC steel sheet from Chemetall, using a PEM-CG2 (Corona) powder spray gun. The amount of conveying air was 4.5 m³/h, and the amount of metering air was 2.0 m³/h. The sprayed sheets were then heated to 120° C. for 20 min in a laboratory drying cabinet, forming a film from the powder layer. After cooling, the surface was roughened with abrasive paper (320 grain), and the abraded dust was removed.

The surfaces coated with coating composition B8 are extremely hydrophobic. When water drops onto the material, the droplets run off the surface without wetting it. The static contact angle with respect to water was more than 160° in all cases.

The repellent power of the surfaces coated with coating composition is 177 mN⁻¹. It was determined using droplets of deionized water. The droplet weight here was 4.3 mg.

III-2 Moldings

Molding compositions F1 to F4 were cast at 70° C. into an aluminum mold. Cooling and drying gave sheets of thickness about 5 mm. Each of molding composition F5 and molding composition F6 was pressed in a press using a pressure of about 7.4·10⁷ Pa, in each case to give a sheet of thickness about 2 mm.

The sheets were slightly roughened using abrasive paper (320 grain) and the abraded dust was removed by washing with water.

The sheets produced from molding compositions F1 to F6 are extremely hydrophobic. When water drops onto the material, the droplets run off the surface without wetting it. The static contact angle with respect to water was more than 160° in all cases.

A molding F1 damaged by scratching with needles likewise had these properties.

A molding F6 damaged by scratching with needles likewise had these properties.

We claim:

1. A composition encompassing at least one hydrophilic, inorganic powder P having an average particle size in the range from 15 to 500 μm and at least one hydrophobic, thermoplastic substance T which is characterized by a surface tension in the range from 20 to 50 mN/m, where the ratio by weight of hydrophilic, inorganic powder to hydrophobic thermoplastic substance P:T is in the range from 50:1 to 1:2.

2. A composition as claimed in claim 1, where the inorganic powder is substantially composed of silicates.

3. A composition as claimed in claim 1 or 2, where the inorganic powder is a powdered quartz.

4. A composition as claimed in any of the preceding claims, where the thermoplastic binder is an oligomer or polymer having a number-average molecular weight above 1 000 dalton.

5. A composition as claimed in claim 4, wherein the polymer is a homo- or copolymer of ethylenically unsaturated monomers and has been selected from polymers whose structure is composed of at least 50% by weight of ethylenically unsaturated monomers A having C₅-C₃₀-alkyl groups and/or C₅-C₁₀-cycloalkyl groups, and, where appropriate, of suitable comonomers B, or else from oligo- and poly-C₂-C₆-olefins.

6. A composition as claimed in any of the preceding claims in the form of a flowable preparation also comprising at least one organic diluent or organic solvent.

7. A composition as claimed in any of claims 1 to 6 in the form of an aerosol, also encompassing at least one propellant.

8. The use of compositions as claimed in any of claims 1 to 7 for producing low-wettability surfaces.

9. A process for producing a low-wettability surface, which comprises applying a coating composition as claimed in any of claims 1 to 7 to a conventional surface.

10. A process as claimed in claim 9, wherein the amount of the composition applied to the surface to be coated is from 0.01 to 1 000 g/m², based on the solid constituents in the composition.

11. A process as claimed in claim 9 or 10, wherein after the coating composition has been applied the resultant surface is roughened.

12. A process for producing a low-wettability surface, which comprises using a shaping process to produce a molding from a composition as claimed in any of claims 1 to 6.

13. A process as claimed in claim 12, wherein the surface of the molding produced by shaping is roughened.

14. A molding, encompassing at least one hydrophilic, inorganic powder P having an average particle size in the range from 15 to 500 μm and at least one hydrophobic, thermoplastic substance T which is characterized by a surface tension in the range from 20 to 50 mN/m, where the ratio by weight of hydrophilic, inorganic powder to hydrophobic thermoplastic substance P:T is in the range from 1:2 to 50:1.

15. The use of compositions as claimed in any of claims 1 to 7 for producing surfaces with self-cleaning effect, and/or for reducing the flow resistance in pipes.
